(19) United States
(12) Patent Application Publication
(10) Pub. No.: US 2015/0360322 A1
(43) Pub. Date: Dec. 17, 2015

(54) LASER DEPOSITION OF IRON-BASED AUSTENITIC ALLOY WITH FLUX

(71) Applicant: Siemens Energy, Inc., Orlando, FL (US)

(72) Inventors: Gerald J. Bruck, Oviedo, FL (US); Ahmed Kamel, Orlando, FL (US)

(21) Appl. No.: 14/302,470

(22) Filed: Jun. 12, 2014

(51) Int. Cl. B23K 26/34; B23K 26/00; B23K 26/16; B23K 25/00

(52) U.S. Cl. CPC B23K 26/345; B23K 25/005; B23K 26/0009; B23K 26/16

(57) ABSTRACT

A method for deposition, welding or repair of iron-based austenitic metal alloys. Particles of the alloy (20) and particles of a flux material (22) are melted with a laser beam (10) to form a melt pool (18) which solidifies into a layer of deposited alloy (24) covered by a layer of slag (26). The flux material contains a constituent effective to scavenge tramp elements such as sulfur, phosphorous and boron from the melt pool. The layer of slag protects the molten alloy from atmospheric contamination and controls the rate of cooling and solidification, resulting in a crack free deposition of crack-prone alloys such as Alloy 20.

### FIELD OF THE INVENTION

This invention relates generally to the field of materials technology, and more particularly to the deposition and/or repair of iron-based austenitic alloys.

### BACKGROUND OF THE INVENTION

Alloy 20, also commonly referred to as Carpenter 20, is described in U.S. Pat. No. 2,185,987 issued 2 Jan. 1940 and has become a standard of comparison against which other corrosion resistant alloys are measured due to its general corrosion resistance, workability, and relatively low strategic alloy content. Common stainless steels such as 304, 309, 316 and 321 stainless steels containing 7-14 wt. % nickel are generally susceptible to stress corrosion cracking. Alloy 20 contains 23-30 wt. % nickel, which places it well outside the region of highest vulnerability to stress corrosion cracking, as indicated on the known Copson curve of FIG. 1.

A problem with Alloy 20 and other similar iron-based austenitic alloys is that they are susceptible to solidification and liquation cracking during welding. Cracking occurs in the weld metal and the adjacent heat affected zone due to the segregation of impurities and the formation of low melting point eutectic compositions at locations that are the last to solidify. In an effort to minimize cracking, it is known to weld Alloy 20 using tungsten inert gas (TIG), metal inert gas (MIG) or submerged arc welding (SAW) techniques incorporating special low residual filler metals, such as alloy ER320LR, which is an alloy having a composition similar to Alloy 20 but with lower carbon, silicon, phosphorous and sulfur levels, as well as tightly controlled niobium and manganese.

Other iron-based austenitic alloys have been developed over time in an effort to overcome the limitations of Alloy 20. See, for example, U.S. Pat. No. 3,168,397 issued 2 Feb. 1965 which discloses Alloy 20Cb3, an alloy similar to Alloy 20 but with improved resistance to corrosion by sulfuric acid and containing about 38% iron compared to about 44% iron in Alloy 20. See also U.S. Pat. No. 4,135,919 issued 23 Jan. 1979 which discloses an air-meltable alloy containing about 26-29 wt % nickel.

In spite of over 70 years of experience with Alloy 20, the industry is still in need of improved methods for welding to and with this versatile alloy.

### BRIEF DESCRIPTION OF THE DRAWINGS

The invention is explained in the following description in view of the drawings that show:

FIG. 1 is a prior art Copson curve.

FIG. 2 illustrates a method in accordance with an embodiment of the invention.

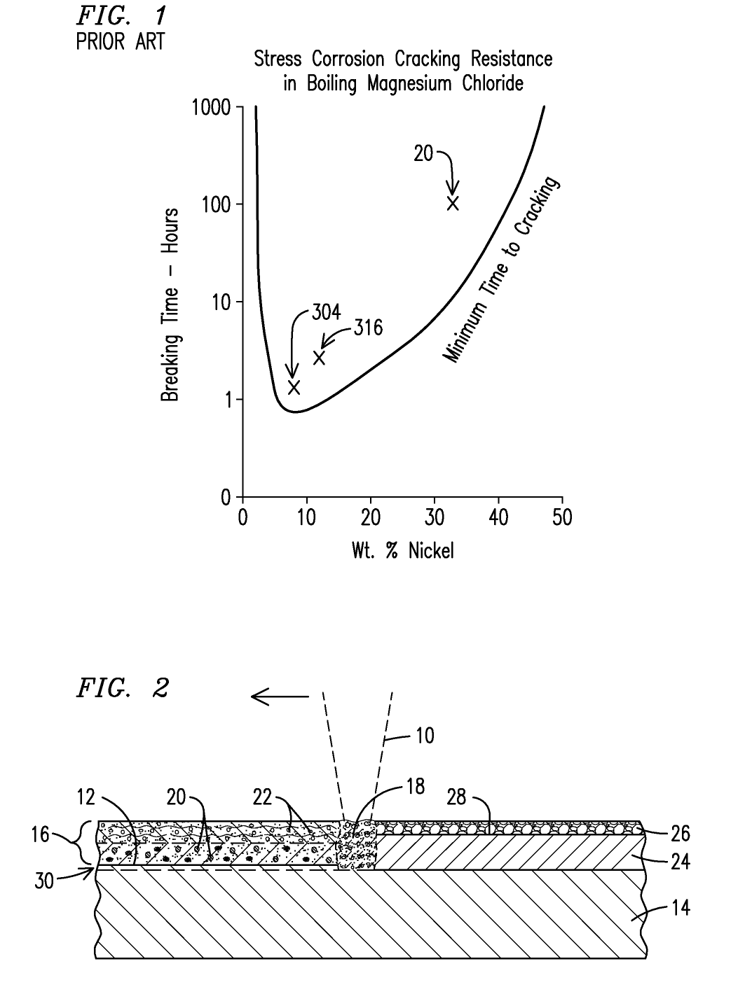

### DETAILED DESCRIPTION OF THE INVENTION

The present inventors have recognized that it is possible to achieve crack free deposits and welds of iron-based austenitic alloys, including Alloy 20, by using a low heat input welding process with a powdered form of a low residual element consumable and a powdered scavenging flux material. One such process is illustrated in FIG. 2 where an energy beam, such as laser beam 10, is traversed across a surface 12 of a substrate 14 in the direction of the arrow to melt a layer 16 of powders to form a melt pool 18. The powders include particles of metal alloy 20 and particles of a flux material 22, which in the embodiment of FIG. 2 are illustrated as distinct layers, although in other embodiments may be mixed together to form a single layer. The melted flux material 22 tends to float on the melted alloy material 20, and as the melt pool 18 solidifies behind the moving laser beam 10, it forms a layer of deposited alloy 24 covered by a layer of slag 26. The layer of slag protects the molten alloy from atmospheric contamination and controls the rate of cooling and solidification. The layer of slag 26 is subsequently removed by known mechanical or chemical methods to reveal a crack-free surface of deposited alloy 28.

An iron-based austenitic alloy containing more than 14 wt. % nickel, for example Alloy 20, may be used in the method of FIG. 2 as either the substrate material 14 or the metal alloy particles 20 or both. Moreover, the substrate 14 may be a stainless steel material containing 7-14 wt. % nickel, for example 304, 309, 316 or 321 stainless steel, with the process used to provide a corrosion resistant layer of iron-based austenitic alloy 24 over the stainless steel. A plurality of layers of material may be deposited over the substrate, with at least the top layer being a corrosion resistant nickel rich alloy (i.e. contains a higher weight percentage of nickel than iron).

The amount of heat input to the process by the laser beam 10 is controlled so that only a thin uppermost layer 30 of the substrate 14, for example a thickness of 0.1-0.5 mm, is melted and incorporated into the melt pool 18. This minimizes the depth of the heat affected zone created by the process, and it allows for a controlled amount of the substrate material to be incorporated into the melt pool 18. In this manner it is possible to deposit an alloy powder 20 containing a higher concentration of nickel and a lower concentration of iron than is contained in the substrate 14, for example to deposit a nickel rich deposited alloy 24 onto a stainless steel substrate 14.

In one embodiment, the alloy powder particles 20 include constituents of Alloy 20 but with less iron than an Alloy 20 composition. Upon melting and incorporation of the topmost layer 30 of the substrate 14 into the melt pool 18, additional iron from the substrate material enriches the melt pool 18 in an amount effective to give the deposited alloy 24 an Alloy 20 composition. A similar approach may be taken to achieve any desired composition of the deposited alloy 24, particularly to achieve a corrosion resistant deposited alloy 24 that is enriched in chrome, nickel, molybdenum, and/or silicon and that contains less iron than the substrate 14. If multiple layers are deposited, it will be recognized that the amount of iron migrating from the substrate 14 into each successive layer will be decreased.

The flux material may contain a constituent effective to scavenge undesired tramp elements from the melt pool 18. The term “tramp element” is used herein to include any element included in a melt whose presence is unimportant or undesirable to the quality of the final product, for example sulfur, phosphorous and boron. The flux material particles 22 may include, for example, at least one of the group of alumina (up to 40 wt. %); silica (and silicates)(up to 40 wt. %); calcium oxide, manganese oxide, and magnesium oxide (combination of these three oxides up to 40 wt. %); fluorides (up to 40 wt. %); and carbonates (up to 5 wt. %).

The process of FIG. 2 may be implemented in an embodiment where the layer of powder 16 includes only particles of flux 22 but no additional alloy. In such an embodiment, when the uppermost layer 30 of substrate 14 is formed as an iron-based austenitic alloy and is melted into melt pool 18 and re-solidified to form a recast layer of alloy 24 under a layer of flux 26, any cracks or discontinuities that had existed in layer 30 will be repaired and recast without cracks. In this embodiment the parameters of energy beam 10 are controlled in a manner effective to obtain a depth of melting of the substrate 14 adequate to repair target discontinuities. The flux 22 also functions to cleanse any contaminants that may have accumulated in any discontinuity in layer 30 that extends to open at surface 12.

While various embodiments of the present invention have been shown and described herein, it will be obvious that such embodiments are provided by way of example only. Numerous variations, changes and substitutions may be made without departing from the invention herein. For example, while the embodiment of FIG. 2 illustrates a cladding or repair process, the material deposition may similarly be used to form a weldment or may be used in an additive manufacturing process. Accordingly, it is intended that the invention be limited only by the spirit and scope of the appended claims.

The invention claimed is:

1. A method comprising:
depositing a powder of an iron-based austenitic alloy comprising greater than 14 wt. % nickel and a powder of a flux material comprising a tramp element scavenging constituent onto a surface of a substrate;
melting the powders with an energy beam to form a layer of melted alloy covered by a layer of slag on the surface;
allowing the melted alloy to solidify under the layer of slag; and
removing the slag to reveal deposited alloy.

2. The method of claim 1, further comprising depositing the powders onto the surface of a stainless steel substrate comprising 7-14 wt. % nickel.

3. The method of claim 1, further comprising depositing the powders onto the surface of an alloy substrate comprising greater than 14 wt. % nickel.

4. The method of claim 1, further comprising depositing the alloy powder onto an Alloy 20 substrate surface.

5. The method of claim 1, further comprising depositing the powder of the flux material to comprise at least one of the group of alumina, silica, calcium oxide, manganese oxide, magnesium oxide, fluorides, and carbonates.

6. The method of claim 1, further comprising depositing the alloy powder to comprise Alloy 20.

7. The method of claim 1, further comprising:
depositing the alloy powder to comprise constituents of Alloy 20 but with less iron than an Alloy 20 composition; and
wherein the melting step also melts a topmost layer of the substrate surface such that iron from the topmost layer is incorporated into the melted alloy in an amount effective to give the deposited alloy an Alloy 20 composition.

8. The method of claim 1, further comprising depositing the alloy powders to comprise a higher concentration of nickel and a lower concentration of iron than contained in the substrate such that the method is effective to deposit a nickel rich deposited alloy onto a stainless steel substrate.

9. The method of claim 1, further comprising melting the powders with a laser beam.

10. A method comprising:
preparing an iron-based austenitic alloy substrate;
depositing a powder comprising particles of an alloy comprising greater than 14 wt. % nickel and particles of a flux material onto the substrate;
melting the powder and a topmost surface layer of the substrate with a laser beam to form a melt pool comprising melted alloy covered by a layer of slag;
allowing the melt pool to solidify under the slag; and
removing the layer of slag to reveal a deposited alloy.

11. The method of claim 10, further comprising depositing particles of the flux material comprising a scavenging constituent effective to remove at least one of sulfur, phosphorous and boron from the melt pool.

12. The method of claim 10, further comprising depositing particles of the flux material comprising at least one of alumina, silica, calcium oxide, manganese oxide, magnesium oxide, fluorides, and carbonates.

13. A method comprising:
depositing a powder comprising particles of a flux material onto an iron-based austenitic alloy substrate;
melting the powder and a topmost surface layer of the substrate with a laser beam to form a melt pool comprising melted alloy covered by a layer of slag;
allowing the melt pool to solidify under the slag; and
removing the layer of slag to reveal a recast alloy surface.

14. The method of claim 13, wherein the flux material comprises at least one of the group of alumina (up to 40 wt. %); silica (and silicates) (up to 40 wt. %); calcium oxide, manganese oxide, and magnesium oxide (combination of these three oxides up to 40 wt. %); fluorides (up to 40 wt. %); and carbonates (up to 5 wt. %).

15. The method of claim 13, wherein the iron-based austenitic alloy substrate comprises Alloy 20.

16. The method of claim 13, wherein the powder comprises particles of an iron-based austenitic alloy.

17. The method of claim 16, wherein both the iron-based austenitic alloy substrate and the iron-based austenitic alloy particles comprise Alloy 20.
